(19) United States
(12) Patent Application Publication
(10) Pub. No.: US 2016/0239590 A1
(43) Pub. Date: Aug. 18, 2016

(54) IDENTIFICATION AND PROTECTION METHOD OF ELECTRIC SHOCK ACCIDENTS

(71) Applicant: XI'AN JIAOTONG UNIVERSITY, Xi'an (CN)

(72) Inventors: Dingxin LIU, Xi'an (CN); Chen CHEN, Xi'an (CN); Xiaohua WANG, Xi'an (CN); Gangyu KONG, Xi'an (CN); Mingzhe RONG, Xi'an (CN)

(73) Assignee: XI'AN JIAOTONG UNIVERSITY, Xi'an (CN)

(21) Appl. No.: 14/807,576

(22) Filed: Jul. 23, 2015

(30) Foreign Application Priority Data
Feb. 13, 2015 (CN) 201510079235.9

(51) Int. Cl. G06F 17/50

(52) U.S. Cl. CPC G06F 17/509; G06F 17/5018

(57) ABSTRACT

The present invention discloses an identification and protection method of electric shock accidents, comprising the following steps:

S100, building a multiport impedance network model of 3D human structure;

S200, building a multiport distribution network model of human electric shock based on the impedance network model of the 3D human structure;

S300, identifying the electric shock accident and taking actions for protection on the basis of the multiport distribution network model of human electric shock, and by use of wavelet and short-term energy methods. Based on the simulation results of the multiport distribution network model of human electric shock, the present invention could obtain the parametric features of zero sequence current from time/frequency domain, then identifies electric shock and start electric leakage protection by the combination of wavelet and short-term energy methods.

### FIELD OF THE INVENTION

The present invention relates to safety utilization of electric power. More specifically, it relates to an identification and protection method of electric shock accidents.

### BACKGROUND OF THE INVENTION

To prevent the electrical fire caused by the electric shock and leakage accident, Residual Current Devices (RCDs) are used commonly in low-voltage distribution network. However, this protection device usually has a relatively high threshold current to trigger the alarm, even close to or reaching 100 mA, far beyond the safety current for the humans. If the protection action against leakage in the electric shock is failed to be triggered, the person will face greater security risks. As a result, how to extract relevant electrical signals for the electric shock accident and make targeted judgment to achieve a quick start of appropriate protection action becomes a technical issue of important significance regarding the safe utilization of electric power in the distribution network.

### SUMMARY OF THE INVENTION

For the defects in the prior art, the present invention provides an identification and protection method of electric shock accidents, wherein the method comprises the following steps:

S100, building a multiport impedance network model of 3D human structure;

S200, building a multiport distribution network model of human electric shock based on the impedance network model of the 3D human structure;

S300, identifying the electric shock accident and starting protection on the basis of the multiport distribution network model of human electric shock and by use of wavelet and short-term energy methods.

### BRIEF DESCRIPTION OF THE DRAWINGS

FIG. 1 is a schematic diagram of the impedance network model of the 3D human structure according to the present invention;

FIG. 2 is a schematic diagram of the two models according to the present invention and the quick identification and protection method of electric shock accidents;

FIG. 3 is a schematic diagram of an exemplary embodiment of the electric shock accident model, wherein RCD is the Residual Current Device for leakage protection, GND is the ground terminal, I₁ is the shock current, and I₂ is the zero-sequence current;

FIG. 4 is a schematic diagram of an exemplary embodiment of the electric shock accidents at different parts on the human body, wherein RCD is the leakage protection device, GND is the common terminal, I₃ is the shock current, and I₄ is the zero-sequence current;

FIG. 5 is a schematic diagram of an exemplary embodiment of the model of different shock positions in the distribution network, wherein RCD is the Residual Current Device for leakage protection, GND is the ground terminal, I₅ is the shock current, and I₆ is the zero-sequence current;

FIG. 6 is a schematic diagram of an exemplary embodiment of the short-term energy method.

### DETAILED DESCRIPTION OF THE INVENTION

In an exemplary embodiment, the present invention discloses an identification and protection method of electric shock accidents, wherein the said method comprises the following steps:

S100, building a multiport impedance network model of 3D human structure;

S200, build a multiport distribution network model of human electric shock based on the impedance network model of the 3D human structure;

S300, identifying the electric shock accident and starting protection on the basis of the multiport distribution network model of human electric shock and by use of wavelet and short-term energy methods.

For this exemplary embodiment, it is based on the multiport distribution network model of the 3D human structure and uses wavelet and short-term energy method to identify the electric shock accident and start the protection action as required. Regarding the multiport impedance network model of 3D human structure, the impedance network model is 3D, so that it can be used for analyzing the electric shock in different parts of the human body. That is to say, it can be used for characterizing the differences brought by connecting impedances of human body into different ports.

Preferred, in another embodiment, the step S100 specifically comprises:

using Cole-Cole theory to calculate and obtain electrical parameters of each stratum and a functional relationship between the electrical parameters and an applied voltage and current according to the structures of corneum, epidermis, dermis, subcutaneous tissue, muscle and bone in different parts of human body, and then building the multiport impedance network model of 3D human structure by substituting the functional relationship into the 3D geometry finite element model, wherein the said electrical parameters include conductivity and permittivity.

That is, the said impedance network model of 3D human structure is built according to the fine structures of corneum, epidermis, dermis, subcutaneous tissue, muscle and bone in the different parts of the human body. The Cole-Cole theory is used for calculating and obtaining the functional relationship between the electrical parameters and the applied voltage and current, and these functions are substituted into the 3D geometry finite element model so as to build the said impedance network model of 3D human structure.

Since the electrical parameters of the human body obtained from the Cole-Cole model are a function of voltages and frequencies of layers of human body, therefore this exemplary embodiment can simulate the electrical phenomenon of the human body exposed to different shock currents by solving the electrical parameters at different voltages and frequencies.

Preferred, in another exemplary embodiment, the said impedance network model of 3D human structure can be used for analyzing the electric shock in the different parts of the human body and the impact from local burn on the body impedance and can also be used for the automatic adjustment of the impedance in different situations of burn.

For this exemplary embodiment, since the impedance network model of 3D human structure is based on the characteristic parameters of the human body, this embodiment can achieve the automatic adjustment of the electrical parameters with these body parameters by solving the electrical parameters of different 3D model. Further, by comprehensively utilizing the characteristics parameters of the human body such as size, age and gender as well as the electrical parameters of the human body affected by different voltages and frequencies, the present invention can also use the same modeling method for these parameters to obtain the respective impedance network model so as to further characterize the impedance information and changes of different groups of people within the scope of common parameters.

That is, the present invention can be used for analyzing the impact of the local burn on the body impedance in the electric shock. For example, the burn of the corneum and epidermis will greatly reduce the body impedance. In this case, during the model calculation, the burnt part can be removed from the overall model calculation to change the impedance of the whole shock path so as to characterize the damage of the current to the human body.

Preferred, in another exemplary embodiment: the step S200 specifically comprises:

Connecting the different ports of the said impedance network model of 3D human structure to the distribution network to build the multiport distribution network model of human electric shock.

For this exemplary embodiment, the multiport distribution network model of human electric shock is built by connecting the impedance network model of 3D human structure to the different distribution networks. The impedance network model of 3D human structure according to the present invention is built by virtue of the microscopic electrical parameters and fine biological structures in the different parts of the human body. The different ports of the model are connected to the distribution network to constitute the multiport distribution network model of human electric shock, which simulates the waveform of the shock current and zero-sequence current flowing through the human body in the electric shock accident so as to evaluate the physiological effect of the electric shock accident on the human body as well as whether to take the protection action.

Preferred, in another embodiment, the multiport distribution network model of human electric shock is used for solving electromagnetic field equation so as to calculate the waveform of the shock current and zero-sequence current flowing through the human body in the electric shock; the said shock current flowing through the body is taken as the standard to evaluate the damage of the electric shock accident to the human body, and the said zero-sequence current is taken as the current standard for the protection action.

For this exemplary embodiment, the electromagnetic field equation under the condition of additional power supply is solved to simulate the waveform of the shock current and zero-sequence current flowing through the human body in the electric shock. The shock current can be taken as the standard to judge the damage of the electric shock accident to the human body; the said zero-sequence current is taken as the current standard for the protection action. If the RCD is used for dealing with the leakage caused by the electric shock, it can reflect the impact of the electric shock accident on the distribution network in accordance with the said zero-sequence current and the detected human grounding impedance and voltage phase angle.

Preferred, the said multiport distribution network model of human electric shock can analyze the impact of the impedance of the distribution network circuit on the shock current and zero-sequence current through the circuit simulation when the human electric shock happens at different positions of the distribution network. Moreover, it can also determine the damage of electric current to the shocked skin, tissue and other body structures by analyzing the electric shock current flowing through the human body when different parts of human body are in the electric shock. As an indicator of the impact of electric shock accident on the human body, the shock current is used for evaluating the impact of the electric shock accident on the human body, such as electroporation and burn. The zero-sequence current is collected by the RCD as the basis for identifying the occurrence of the electric shock accident and whether to start the protective action.

Preferred, in another exemplary embodiment, the said multiport distribution network model of human electric shock is connected to the multiport impedance network model of 3D human body in the case of different sizes, ages and genders to determine the corresponding shock current and zero-sequence current when electric shock occurs in the situations of different sizes, ages and genders.

In summary, when the said multiport distribution network model of human electric shock is connected to the multiport impedance network model of 3D structure with the different human body characteristics such as size, age and gender, the shock current and zero-sequence current crrespoingding to these different groups of people suffered from electric shock can be obtained. At the same time, the shock current flowing through the human body when the different parts of human body are in the current shock is analyzed to determine the thermoelectric damage of the current to the shocked skin, tissue and other body structures.

Preferred, in another exemplary embodiment, the said method uses the wavelet analysis method for the time/frequency domain decomposition of the zero-sequence current obtained, and the amplitude and phase are discriminated to effectively filter out the leakage current of power frequency and its harmonic waves so as to identify and extract the waveform of the feature band reflecting the electric shock.

For this exemplary embodiment, the wavelet analysis method (e.g. wavelet packet method) is used in the present invention for the time/frequency domain decomposition of the waveform of the zero-sequence current obtained, and the amplitude and phase are discriminated to effectively filter out the leakage current of power frequency and it harmonic waves so as to identify and extract the waveform of the feature band reflecting the electric shock. The wavelet analysis method decomposes the signals in accordance with the frequency to separate several different types of current signals and reconstructs the useful stratum to finally obtain the desired signals.

Preferred, in another exemplary embodiment, the said method uses the sliding Hamming window function for obtaining the short-term energy function from the waveform of the feature band reflecting the electric shock so as to make the multi-parameter description of this short-term energy function, including amplitude and rate of change, and finally the said multi-parameter description is used for identifying the electric shock and starting the protection action.

For this embodiment, the present invention uses the sliding Hamming window function for obtaining the short-term energy function from the zero-sequence current waveform so as to make further description of this short-term energy function, including amplitude and rate of change, and finally the said multi-parameter description is used for identifying the electric shock. The wavelet analysis method can not only effectively eliminate noises but also reserve the overall and local features of the original signal. The de-noised signal can be identified by the short-term energy method.

The short-term energy method is one of the short-term analysis methods, which is often used for voice signal processing. Exemplarily, the short-term energy function is defined as:

$$\begin{matrix}S ( n ) = {\sum }_{i = - ∞}^{+ ∞} {x}^{2} ( i ) w ( n - i ) \\ = {\sum }_{i = n - M + 1}^{n} {x}^{2} ( i ) w ( n - i ) \\ = {x}^{2} ( n ) w ( n )\end{matrix}$$

Where:

w(n) is the sliding window function, n=0, . . . , M−1;

S(n) represents the local energy of the signal at the moment of n.

In the case of the fixed sampling rate, the shorter the window length is, the higher the time resolution is. However, too short window length would affect the short-term analysis method to give play to the high signal to noise ratio. Therefore both must be weighed for the selection of the window function.

That is, the present invention combines wavelet and short-term energy method and is based on the simulation results of the multiport distribution network model of human electric shock to make parametirc analysis of the zero-sequence current model containing the electric shock accident and obtain the parametric features of zero-sequence current of electric shock from the time-frequency domain so as to identify the electric shock and start electric leakage protection.

Preferred, in another exemplary embodiment, the said protection action is started by the leakage protection device. The said leakage protection device contains a programmable device, and the said programmable device can start the protection action based on the contrast between the said multiple parameters and electric shock accident standard.

Exemplarily, when the leakage current caused in the leakage accident is relatively weak, the sampling rate between 10 kHz and 10 MHz is selected. The waveform data is processed through the programmable device every 5 ms to complete the analysis and processing of a cycle of data within 15 ms. The occurrence of the electric shock can be determined in the comparison of collected voltage waveform and the short-term energy waveform of the feature band with the preset criteria of the electric shock accident (e.g. the feature information in the knowledge base). If no more than 10 parameters are compared, the required time can be negligible compared to 20 ms.

Below in combination with the drawings, the present invention is further described in other embodiments.

### Embodiment A

As shown in FIG. 1, the fine structure at the biological tissue level is taken into account for the model of human body, i.e. corneum, epidermis, subcutaneous tissue, muscle, bone, organ, nerve tissue, the Cole-Cole theory is used for calculating the function of electrical parameters (conductivity and permittivity) changing with the external conditions (applied voltage, current and frequency), which is substituted into the 3D geometry finite element model. Therefore, as the model is connected to the distribution network model for the analog computation, the body forms a multiport impedance network model, and the electrical parameters such as the shock current flowing through the human body can be obtained by solving the electromagnetic field equation.

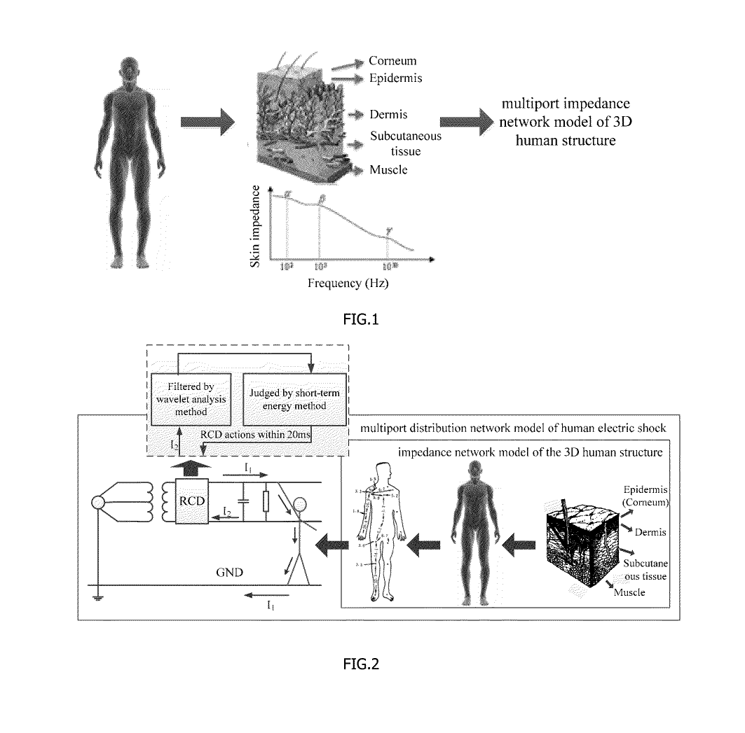

As shown in FIG. 2, after the specific multiport impedance network model of 3D human body is built, it can be combined with the distribution network model to simulate the shock current (I₁) flowing through the human body and the zero-sequence current (I₂) flowing through the RCD.

As the programmable device is applied in the RCD, the wavelet analysis method is used for filtering and extracting the zero-sequence current signal and the short-term energy method is used for judging the extracted current signal so as to start the protection action within 20 ms.

Embodiment A of the present invention is described as above, and the application process of the method is further described below.

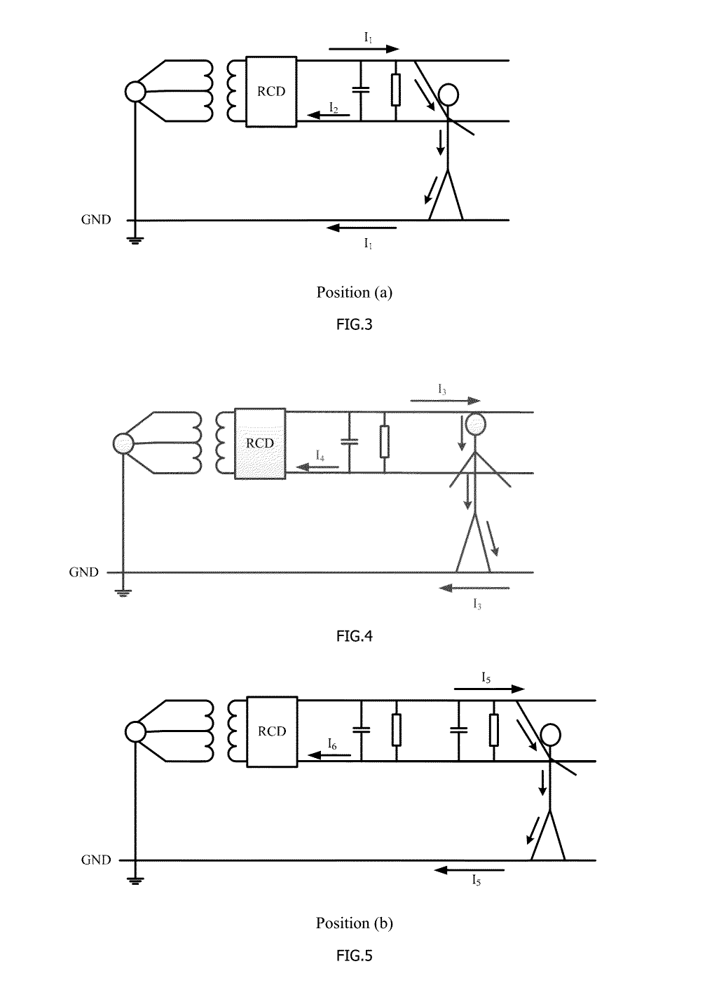

Referring to FIG. 3, in the present embodiment, the electric shock occurs in position (a) of a human body, which is on the single hand and foot. The current path is one hand→one arm→trunk→one leg→one foot, and the shock current flowing through the human body is I₁. The multiport impedance network model of human body automatically substitutes the impedance of this path into the calculation. See FIG. 1. The zero-sequence current flowing through the RCD is I₂. After I₂ is detected by the RCD, the programmable control device starts the appropriate analysis program and uses the wavelet analysis method and short-term energy method to determine whether I₂ reaches the standard for the electric shock. If so, the protection action is started within 20 ms and the circuit is disconnected to cut off the shock current I₁ flowing through the human body. For this embodiment, the damage of the shock current to the body tissue can be further accurately analyzed at the micro level, in order to provide a reference for the designated protection threshold.

### Embodiment B

This embodiment highlights the difference from Embodiment A and omits the similarity.

Referring to FIG. 4, the difference of this embodiment from Embodiment A is the shocked part of the human body. In this embodiment, when the head is shocked, the current path formed is as follows: head→neck→trunk→one leg→one foot. Since the current path is changed, the circuit impedance is changed. Therefore the shock current I₃ flowing through the body and the zero-sequence current I₄ detected by the RCD are both changed. The multiport distribution network model of human electric shock can automatically and promptly adjust and start RCD algorithm and judge I₄ to decide whether to start the protection action. This embodiment can accurately analyze the damage of I₃ to the body tissue at the micro level, in order to provide a reference for the designated protection threshold.

### Embodiment C

This embodiment highlights the difference from the above two embodiments and omits the similarity.

Referring to FIG. 5, the difference of this embodiment from the above two embodiments is the position where the person is shocked. In above two embodiments, it is at position (a) that the body is shocked, while in this embodiment, the electric shock occurs at position (b). Due to the impact of the impedance of the distribution network itself, the shock current I₅ and zero-sequence current I₆ in the present embodiment are different from the above two embodiments. The multiport electric network model of human electric shock can automatically and promptly adjust and start RCD algorithm and judge I₆ to decide whether to start the protection action. This embodiment can accurately analyze the damage of I₅ to the body tissue at the micro level, so as to provide a reference for the designated protection threshold.

### Embodiment D

This embodiment highlights the use of the short-term energy method for the detection of zero-sequence current signal.

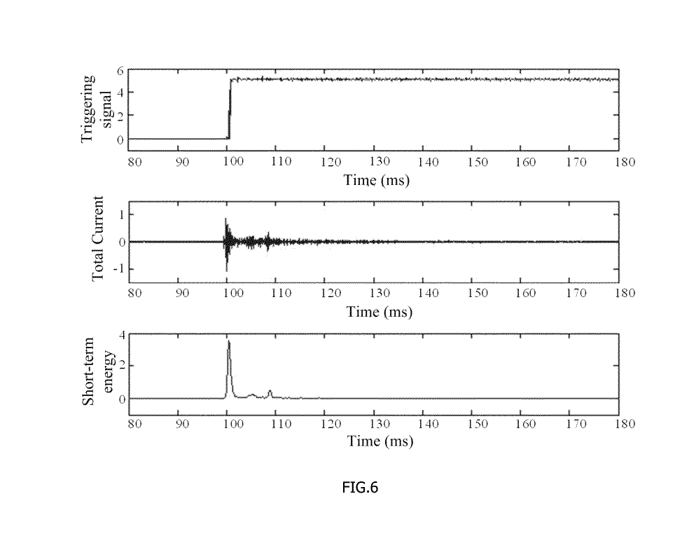

Referring FIG. 6, in this embodiment, the short-time energy method is used for detecting the total current signal, which can be substituted into the short-time energy function S(n) to clearly extract the waveform features in the current signal. The short-term energy method first makes exponential transformation of the signal and then uses the moving finite long window to weigh it. The short-term energy method can further weaken the impact of the noise and the noise signal and strengthen the useful vibration signal. The integral of the signal can be extracted within the finite window as the basis for identifying the signal of the shock current.

In summary, the present invention has the following advantages:

(1) The 3D model is built on basis of the fine biological structure of the human body and overcomes the simple description of traditional methods;

(2) Different damages of the electric shock to the different groups of people can be analyzed. And the differences between size, age, gender, etc. can be more accurately described;

(3) The electric shock in different parts can be analyzed, equivalent to the differences arising from the body impedance being connected to different ports;

(4) The impact of local burn on the human body can be analyzed to immediately reflect the changes of the body impedance as the corneum and epidermis are burnt;

(5) The impact of the electric shock accident on the distribution network circuit, voltage phase angle and grounding impedance can be fully considered and these factors can be extracted and reflected in the characteristics of the zero-sequence current;

(6)The wavelet analysis method (e.g. wavelet packet method) is used for the time-frequency domain decomposition of the waveform of the zero-sequence current obtained, and the leakage current of power frequency and its harmonic waves can be effectively filtered out so as to provide the waveform of the feature band reflecting the electric shock;

(7) The short-term energy method can be used for the multi-parameter description of the zero-sequence current so as to obtain the basis for the judgment of the electric shock;

(8) Based on the above advantages, the protecting action can be started in a very short period of time, such as less than 20 ms, to protect human safety.

In this specification, what is highlighted for each embodiment is different from others, and the same or similar parts between various embodiments can be referred to from each other.

The present invention is described in detail above, its principle and mode of execution are demonstrated with specific embodiments. The above embodiments are described only to help understand the method and core idea of the present invention; at the same time, the person skilled in the art can change the specific embodiments and applications according to this inventive concept. In summary, the contents of this specification should not be interpreted as the limit to the present invention.

1. An identification and protection method of electric shock accidents, characterized in that, the method comprises the following steps:
S100, building a multiport impedance network model of 3D human structure;
S200, building a multiport distribution network model of human electric shock based on the impedance network model of the 3D human structure;
S300, identifying the electric shock accident and starting protection on the basis of the multiport distribution network model of human electric shock and by use of wavelet and short-term energy algorithm.

2. The method according to claim 1, characterized in that the step S100 specifically comprises:
using Cole-Cole theory to calculate and obtain electrical parameters of each stratum and a functional relationship between the electrical parameters and an applied voltage and current according to structures of corneum, epidermis, dermis, subcutaneous tissue, muscle and bone in different parts of human body, and then building the multiport impedance network model of 3D human structure by substituting the functional relationship into 3D geometry finite element model, wherein the said electrical parameters include conductivity and permittivity.

3. The method according to claim 2, wherein the said 3D impedance network model can be used for analyzing the electric shock of different parts of the human body as well as the impact from local burn occurring in the electric shock on the body impedance, and in addition it can also be used for the automatic adjustment of the entire body impedance in the different situations of burn.

4. The method according to claim 1, wherein the step S200 specifically comprises: connecting different ports of the impedance network model of the 3D human structure to the distribution network to build the multiport distribution network model of human electric shock.

5. The method according to claim 4, wherein using multiport distribution network model of human electric shock to solve electromagnetic field equation so as to calculate the waveform of the shock current and zero-sequence current in the case of electric shock accident;
and then taking the shock current flowing through the human body as a standard to estimate the damage of the electric shock accident to the human body, and taking the said zero-sequence current as the current standard for protection action.

6. The method according to claim 4, wherein the multiport distribution network model of human electric shock can analyze the impact of the impedance of the distribution network circuit on the shock current and zero-sequence current through the circuit simulation when the shock accidents happened at different positions of the distribution network, it can also analyze the damage of electric current to the shocked skin, tissue and other body structures when the different parts of human body are in the electric shock.

7. The method according to claim 5, wherein connecting the multiport distribution network model of human electric shock the multiport impedance network model of 3D human structure in the case of different sizes, ages and genders to determine the corresponding shock current and zero-sequence current.

8. The method according to claim 7, wherein the method uses the wavelet analysis method for the time-frequency domain decomposition of the zero-sequence current obtained, discriminates amplitude and phase to effectively filter out the leakage current of power frequency and harmonic waves, and identifies and extracts the waveform of the feature band reflecting the electric shock.

9. The method according to claim 8, wherein the method uses a sliding Hamming window function to calculate a short-term energy from the waveform of the feature band reflecting the electric shock so as to obtain a short-term energy function, an then makes the multi-parameter description of this short-term energy function, including amplitude and rate of change, and finally uses the multi-parameter description to identify the electric shock and start the protection action.

10. The method according to claim 9, wherein the protection action is started by the leakage protection device, the leakage protection device contains a programmable device, and the programmable device starts the protection action based on the contrast between the multiple parameters and electric shock accident standard.

11. The method according to claim 6, wherein connecting the multiport distribution network model of human electric shock the multiport impedance network model of 3D human structure in the case of different sizes, ages and genders to determine the corresponding shock current and zero-sequence current.
